(19) United States
(12) Patent Application Publication
(10) Pub. No.: US 2020/0175626 A1
(43) Pub. Date: Jun. 4, 2020

(54) ANALYZING PATENT VALUE IN ORGANIZATIONAL PATENT PORTFOLIO STRATEGY

(71) Applicant: International Business Machines Corporation, Armonk, NY (US)

(72) Inventors: Harish Bharti, Pune (IN); Sharath Sampath, Bangalore (IN); Rajesh Kumar Saxena, MAHARASHTRA (IN); Sreenath Raghunath, PUNE (IN)

(21) Appl. No.: 16/207,261

(22) Filed: Dec. 3, 2018

(51) Int. Cl. G06Q 50/18; G06Q 40/06; G06F 17/16

(52) U.S. Cl. CPC G06Q 50/184; G06F 17/16; G06Q 40/06

(57) ABSTRACT

A system and method for identifying a value gap in a patent portfolio strategy of an organization. A processor of a computing system defines a first data cluster that includes a first plurality of focus areas that are ranked according to an internal ranking of the organization, and a second data cluster that includes a second plurality of focus areas having a universal market significance. A patent worthiness is ranked so that the second plurality of focus areas is ranked according to a universal ranking. A Kemeny distance is calculated between the internal ranking and the universal ranking for each focus area of the first plurality of focus areas. A loss function is applied using the Kemeny distance to calculate the value gap score which defines a business penalty for the misalignment between the patent portfolio strategy of the organization and a universal market focus.

### TECHNICAL FIELD

The present invention relates to systems and methods for analyzing patent value or identifying a value gap in organizational patent strategy, and more specifically the embodiments relate to a value identification system for identifying a value gap score in a patent portfolio strategy of an organization.

### BACKGROUND

Organizations may invest heavily on defining an intellectual property (IP) strategy to ensure that the organization will not only cater to current market needs but will also be relevant for a number of years in future. However, with an ever-changing technology landscape it is

becoming increasing difficult to define a precise view of strategic focus domains for an organization. As a result, organizations realize too late that they should have extended their products and services in a domain which they decided not to focus initially. For example, organization could have explored options of partnerships or acquisitions to ensure they capture right market opportunities if they could foresee the shift. Inputs for defining organization strategy can be improvised to an extent that it cognitively identifies domains which can be of importance to organization.

### SUMMARY

An embodiment of the present invention relates to a method, and associated computer system and computer program product for identifying a value gap in a patent portfolio strategy of an organization. A processor of a computing system defines a first data cluster that includes a first plurality of focus areas that are ranked according to an internal ranking of the organization, and a second data cluster that includes a second plurality of focus areas having a universal market significance. A patent worthiness of the second plurality of focus areas is ranked using a plurality of factors, so that each focus area of the second plurality of focus areas is ranked according to a universal ranking. A Kemeny distance is calculated between the internal ranking and the universal ranking for each focus area of the first plurality of focus areas, wherein the Kemeny distance between the internal ranking and the universal ranking represents a misalignment between the patent portfolio strategy of the organization and a universal market focus. A loss function is applied using the Kemeny distance to calculate the value gap score which defines a business penalty for the misalignment between the patent portfolio strategy of the organization and a universal market focus.

### BRIEF DESCRIPTION OF THE DRAWINGS

FIG. 1 depicts a block diagram of an organization strategy value identification system, in accordance with embodiments of the present invention.

FIG. 2 depicts a schematic diagram of a first cluster and a second cluster, in accordance with embodiments of the present invention.

FIG. 3 depicts a block diagram of the overall organization strategy value identification system, in accordance with embodiments of the present invention.

FIG. 4 depicts a flow chart of a method for identifying a value gap in a patent portfolio strategy of an organization, in accordance with embodiments of the present invention.

FIG. 5 depicts a more detailed flow chart of a method for identifying a value gap in a patent portfolio strategy of an organization, in accordance with embodiments of the present invention.

FIG. 6 depicts a block diagram of a computer system for an organization strategy value identification system of FIGS. 1-3, capable of implementing a method for identifying a value gap in a patent portfolio strategy of an organization of FIGS. 4-5, in accordance with embodiments of the present invention.

FIG. 7 depicts a cloud computing environment, in accordance with embodiments of the present invention.

FIG. 8 depicts abstraction model layers, in accordance with embodiments of the present invention.

### DETAILED DESCRIPTION

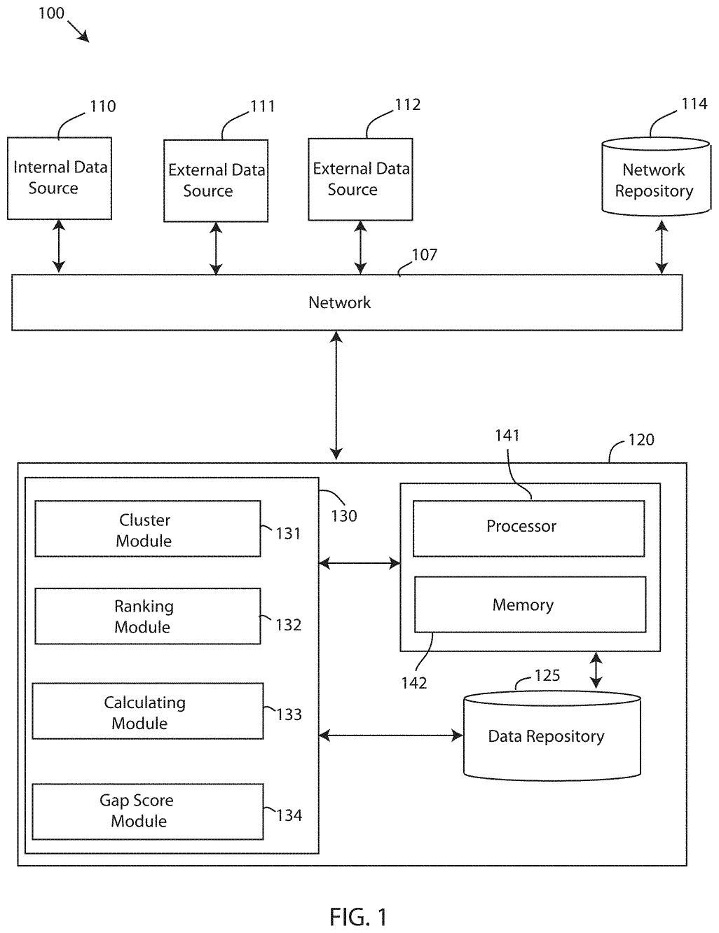

Referring to the drawings, FIG. 1 depicts a block diagram of an organization strategy value identification system 100, in accordance with embodiments of the present invention. The organization strategy value identification system 100 is a system for providing inputs while defining an organization strategy by identifying intellectual property (IP) value gap in portfolio of the organization based on market potential trends and disruptive changes. The organization strategy value identification system 100 may be useful for organization seeking to improve IP strategy by analyzing external market influences and data sources. Embodiments of the organization strategy value identification system 100 may be alternatively referred to as a value gap system, a cognitive value gap strategy system, and the like.

Further, the organization strategy value identification system 100 is used to determine: (i) whether an organization has identified all products, services and domains important for the organization's IP filing strategy, (ii) an impact of domains an organization is not currently focusing on as part of a current IP strategy, and (iii) whether there are certain domains of high importance to a given market but are not currently part of the organization's current IP strategy. Failing to include domains of high importance to the market in the patent portfolio building strategy results in an adverse business impact, such as lost opportunities, a devaluing of a patent portfolio, costs incurred for corrective action, etc. Accordingly, the organization strategy value identification system 100 distinguishes a focus or strategy of an organization from a focus or strategy of an overall market to identify a misalignment between the organization and the market that allows the organization to understand a business impact if the current strategy is not corrected. In an exemplary embodiment, the organization strategy value identification system 100 distinguishes a patent portfolio building strategy of an organization from an overall market ranking of technical fields available for patenting to identify a misalignment between the organization's focus on technical fields via patent applications filed and the market's view on technical fields that allows the organization to understand a business impact if the current patent portfolio building strategy remains unchanged in view of the market trends.

The organization strategy value identification system 100 includes a computing system 120. Embodiments of the computing system 120 include a computer system, a computer, a server, one or more servers, a backend computing system, and the like.

Furthermore, the organization strategy value identification system 100 includes an internal data source 110 and external data sources 111, 112 that are communicatively coupled to the computing system 120 over a network 107. For instance, information/data is transmitted to and/or received from the internal data source 110 and the external data sources 111, 112 over a network 107. In an exemplary embodiment, the network 107 is a cloud computing network. Further embodiments of network 107 refer to a group of two or more computer systems linked together. Network 107 includes any type of computer network known by individuals skilled in the art. Examples of network 107 include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. In one embodiment, the architecture of the network 107 is a peer-to-peer, wherein in another embodiment, the network 107 is organized as a client/server architecture.

In an exemplary embodiment, the network 107 further comprises, in addition to the computing system 120, a connection to one or more network-accessible knowledge bases 114, which are network repositories containing information of the organization preferences, organization IP filing activity, organization predefined rules, specific filing rules, organization location, etc., network repositories or other systems connected to the network 107 that are considered nodes of the network 107. In an embodiment where the computing system 120 or network repositories allocate resources to be used by the other nodes of the network 107, the computing system 120 and network-accessible knowledge bases 114 is referred to as servers.

The network-accessible knowledge bases 114 is a data collection area on the network 107 which backs up and save all the data transmitted back and forth between the nodes of the network 107. For example, the network repository is a data center saving and cataloging the organization preferences, organizing IP filing activity, organization predefined rules, specific filing rules, organization location, etc., and the like, to generate both historical and predictive reports regarding a particular organization or a particular IP strategy of an organization. In an exemplary embodiment, a data collection center housing the network-accessible knowledge bases 114 includes an analytic module capable of analyzing each piece of data being stored by the network-accessible knowledge bases 114. Further, the computing system 120 can be integrated with or as a part of the data collection center housing the network-accessible knowledge bases 114. In an alternative embodiment, the network-accessible knowledge bases 114 are a local repository that is connected to the computing system 120.

The internal data source 110 is a data source internal to an organization. Examples of internal data source 110 include existing filing strategies, current organizational IP rankings (i.e. internal ranking IR), organizational procedures, internal documents, internal organization enterprise data, and the like. External data sources 111, 112 are data sources external to the organization. Examples of external data sources 111, 112 include objective sources, objective rankings, publicly available publication, public and government statistics, experts, and the like.

Referring back to FIG. 1, the computing system 120 of the organization strategy value identification system 100 is equipped with a memory device 142 which stores various data/information/code, and a processor 141 for implementing the tasks associated with the organization strategy value identification system 100. An organization strategy value identification application 130 is loaded in the memory device 142 of the computing system 120. The organization strategy value identification application 130 can be an interface, an application, a program, a module, or a combination of modules. In an exemplary embodiment, the organization strategy value identification application 130 is a software application running on one or more back end servers (e.g. computing system 120).

The organization strategy value identification application 130 of the computing system 120 includes a cluster module 131, a ranking module 132, a calculating module 133, and a gap score module 134. A “module” refers to a hardware-based module, a software-based module, or a module that is a combination of hardware and software. Hardware-based modules include self-contained components such as chipsets, specialized circuitry and one or more memory devices, while a software-based module is a part of a program code or linked to the program code containing specific programmed instructions, which is loaded in the memory device of the computing system 120. A module (whether hardware, software, or a combination thereof) is designed to implement or execute one or more particular functions or routines.

The cluster module 131 includes one or more components of hardware and/or software program code for defining a first cluster and a second cluster. The first cluster includes a first plurality of focus areas that are ranked according to an internal ranking of the organization. The focus areas are technology fields, domains, technical trends, research topics, scientific endeavors, technology areas, emerging science fields, emerging technologies, and the like. Examples of focus areas includes blockchain, artificial intelligence, etc. The focus areas clustered together are associated with trends and domains currently part of an organization focus. For example, a technology area that is currently being researched by an organization would be included in the first cluster. Each of the focus areas of the first cluster are ranked by an internal ranking of the organization. The internal ranking of the organization is performed using internal data sources 110. The internal data sources can be used to develop and finalize the internal rankings of the organization prior to the clustering of the cluster module 131. In other words, the internal ranking of the focus areas may already be completed internally by the organization, such that the cluster module 131 obtains the internal rankings as a function of the clustering of the focus areas within the first cluster. The cluster module 131 builds the first cluster by extracting data/information from the internal data source(s) 110 that provide organizational data and statistics, such as patent tiling data, customer engagements, internal budgets to specific internal departments, a number of employees assigned to a project, a market investment portfolio, new constructions, newly created jobs data, employee feedback, research data, research and development activity, and the like. Accordingly, the cluster module 131 builds a first cluster associated with an organization,

Moreover, the cluster module 131 builds a second cluster associated with a universal or objective market view. The second cluster includes a second plurality of focus areas having a universal market significance, which may include focus areas that overlap the focus areas associated with the organization. Market significance refers to value, impact, significant, profitability, technological growth, etc. attributed to the focus areas. Similar to the focus areas contained in the first cluster, the focus areas contained in the second cluster includes technology fields, domains, technical trends, research topics, scientific endeavors, technology areas, emerging science fields, emerging technologies, and the like. The focus areas clustered together are associated with trends and domains based on an objective, external view of the market. For example, a technology area that is currently being listed in several publications as an emerging technology would likely be included in the second cluster. The cluster module 131 builds the second cluster 131 by extracting data/information from the external data sources 111, 112 that provide insights into industry trends, objective evaluations, market analysis, investment trends, third party opinions on a particular focus area, and the like. Accordingly, the cluster module 131 builds a second cluster associated with an objective, universal market view, external to the organization.

The ranking module 132 includes one or more components of hardware and/or software program code for ranking a patent worthiness of the second plurality of focus areas using a plurality of factors, so that each focus area of the second plurality of focus areas is ranked according to a universal ranking. For instance, the ranking module 132 calculates or otherwise determines a patent worthiness of each focus area of the second cluster to establish a universal ranking based on industry trends, objective evaluations, market analysis, investment trends, third party opinions on a particular focus area, and the like. Patent worthiness refers to a degree of deservedness that focus, attention, budget, money, human resources, etc. should be aimed at a focus area such that patent applications should be filed in these focus areas to add value to a patent portfolio. The patent worthiness is calculated using external sources 111, 112, such as government entities, publicly accessible servers, libraries, websites, third party databases, Internet, and the like. While FIG. 1 depicts external source 111 and external source 112, the organization strategy value identification system 100 may include more external sources of the same or different types. The ranking module 132 uses the external data sources 111, 112 to determine a plurality of factors used to calculate patent worthiness. The plurality of factors includes a total dollar amount of investments into the focus area, a total number of patent applications filed in the focus area, a number of organizations researching the focus area, market results linked to the focus area, a number of peer-reviewed articles published on a topic, magazine articles written on the focus area, a demand for subject matter experts in the focus area, a streaming data for videos on the focus area, and the like. The external data can be used to develop and finalize the universal rankings that are assigned to each of the focus areas. Accordingly, the ranking module 132 develops and assigns the universal rankings to the focus areas contained in the second duster based on a patent worthiness of the focus areas.

The internal rankings and the universal rankings can be calculated according to various formulas, algorithms, methodologies, and the like. In an exemplary embodiment, the internal rankings associated with the first cluster are represented by the following formula:

X_{O}¹={X₁¹,X₂¹, . . . Xₘ¹|Xₘ¹∈N (eq. 1)

wherein in is a number of focus areas included in the internal rankings. Similarly, the universal rankings associated with the second cluster are represented by the following formula:

X_{U}²={X₁²,X₂², . . . Xₙ²|Xₙ²∈N (eq. 2)

wherein n is a number of focus areas included in the universal rankings. Accordingly, the rank of a focus area according to the internal rankings of the organization and universal rankings based on the external market view, respectively, is represented by X_{O,U}^{1,2}.

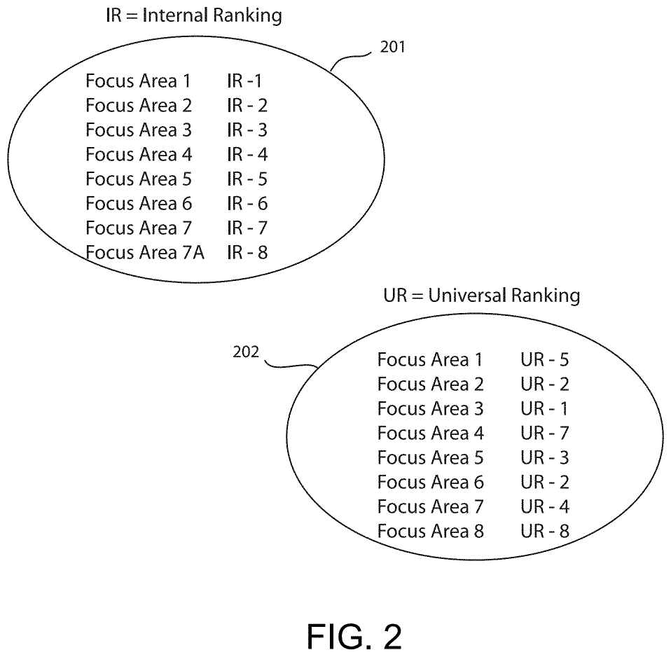

FIG. 2 depicts a schematic diagram of a first cluster and a second cluster, in accordance with embodiments of the present invention. In the illustrated embodiment, a first cluster 201 is shown having eight focus areas labeled Focus Area 1-7A. The internal ranking (IR) for each of the eight Focus Areas is included in the first cluster 201. A second cluster 202 is also shown having eight focus areas labeled Focus Area 1-8. The universal ranking (IR) for each of the eight Focus Areas is included in the second cluster 202. Focus Areas 1-7 are included in both the first cluster 201 and the second cluster 202 (e.g. the focus areas overlap). However, the internal rankings of Focus Areas 1-7 vary from the universal rankings of the same Focus Areas 1-7. Additionally, the first cluster 201 includes Focus Area 7A which is not present in the second cluster 202, while Focus Area 8 is included only in the second cluster 202, and not in the first cluster 201.

Referring back to FIG. 1, the calculating module 133 includes one or more components of hardware and/or software program code for determining a Kemeny distance between the internal ranking and the universal ranking for each focus area of the first plurality of focus areas. Kemeny distance refers to a minimum number of interchanges of two adjacent elements required to transform one ranking into another. For example, the Kemeny distance defines a number of interchanges or switches to transform an internal ranking of “4” to a “1”. Here, the Kemeny distance between the internal ranking(s) and the universal ranking(s) represents a misalignment between the patent portfolio building strategy of the organization and a universal market focus. In other words, a discrepancy between the organization's current patent portfolio building strategy, based on internal rankings of focus areas, and a market focus on focus areas, based on market data and industry trends and domains, is represented by the Kemeny distance.

The Kemeny distance is equivalent a coefficient of disarray. As a result, the calculations module 133 calculates a coefficient of disarray to determine a number of switches or interchanges that transform a ranking of a focus area of the first cluster into a ranking of the same focus area of the second cluster. The coefficient of disarray (e.g. Kendall tao) is calculated according to the following formula:

$$τ = 1 - \frac{2 s}{\frac{1}{2} n ( n - 1 )} \qquad ( Eq . 3 )$$

wherein τ is the coefficient of disarray, s is a kendal distance, and n is a list size. The Kendal distance is the distance between the organization list and the universal list having n observations. For instance, using Kendall tao, the coefficient of disarray is defined as the minimum number of switches which transform any ranking into any other ranking of the same number of objects. The equivalence between τ and s establishes their connection with a permutation polytope, and thus their fundamental relevance for the reordering of these rankings, because s is just a graphical distance. Therefore, Kemeny distance, dₖₑₘ, is represented according to the following formula:

dₖₑₘ=½Σᵢ₌₁^{m}Σⱼ₌₁²|(X_{U}²)ᵢⱼ| (Eq. 4)

where m is the number of focus areas in the internal, organization ranking, and n is the number of focus areas in the universal ranking.

The gap score module 134 includes one or more components of hardware and/or software program code for applying, by the processor, a loss function using the Kemeny distance to calculate a value gap score which defines a business penalty for the misalignment between the patent portfolio strategy of the organization and a universal market focus. For instance, the gap score module 134 identifies a value gap that helps an organization understand the penalties, costs, business implications, effects, etc. (e.g. business penalty) if the organization maintains a misalignment with the market focus. The business penalty also defines a qualitative view of a business impact and cost incurred in an absence of pursing IP protection on key trends, domains, focus areas, and the like indicated as having market significance. resulting in identifying the value gap in the patent portfolio strategy of the organization.

In an exemplary embodiment, the larger the value gap, the more severe the predicted business penalty is to the organization. Similarly, the smaller the value gap, the less severe the predicted business penalty is to the organization. As a result, the gap score module 134 dynamically responds to the value gap score information. By way of example, the gap score module 134 recommends one or more modifications to the patent portfolio building strategy of the organization to reduce the gap score. The recommendation can be a suggestion, recommendation, alert, message, etc. that is sent to one or more computing devices having specific graphical user interfaces (GUIs) depicting the value gap score information. The gap score module 134 can send alerts if the value gap score exceeds a certain threshold, or the gap score module 134 can modify or otherwise augment the specific GUIs to display value gap score information tailored to a particular organization. Further, the dynamic response includes sending alerts/recommendations that are configured to be sent to specific departments of an organization that are associated with a focus area that has a higher universal ranking than an internal ranking.

Moreover, the Kemeny distance shows that probability and distance are inversely related, which means that a loss function can be employed to calculate the value gap score. Various loss functions can be used to calculate the value gap score. In an exemplary embodiment, the loss function is a K-Median Cluster Component Analysis (CCA) that uses the following formula:

CCA(P,S₁, . . . ,S_{K})=Σₛ₌₁^{n≢Σ}ₖ₌₁^{K}pₖ²(Rₛ)d_{Kem}(Rₛ,Sₖ) (Eq. 5)

wherein Pₖ(R_{S}) is a probability of allocating ranking s to cluster component k, Sₖ is a center of component k for k=1, . . . , K, and P=P is the n×K matrix of allocation probabilities. If Eq. 5 is differentiated with respect to Pk(Rs), subject to the constraint that allocation probabilities for a given ranking sum to one, the stationary equation is obtained:

pₖ(Rₛ)d_{Kem}(Rₛ,Sₖ)=constant depending on Rₛ (Eq. 6).

The stationary equations of the CCA optimization problem are consistent with the principle of probability being inversely related to distance. During the recursive partitioning process in which a nested sequence of subsamples is formed, it is determined, for each possible split along the coordinate axis of any variable, the gap of the subsamples is formed. The set of rankings are portioned with an aim to predict the differences in the rankings. During the recursive partitioning partition process, the gap measure for every possible split is determined. Accordingly, the value gap score, G, is calculated according to the formula:

$${G}_{O * U} = \frac{1}{\frac{1}{2} τ ( τ - 1 )} {Σ}_{s ∈ G}^{{n}_{l}} {Σ}_{t ∈ G}^{{n}_{l}} {d}_{Kem} ( {R}_{s} , {S}_{k} ) \vert s > t \qquad ( Eq . 7 )$$

wherein nₗ is a current focus area in the first cluster and having an internal rank, and τ is the coefficient of disarray provided as Eq. 3.

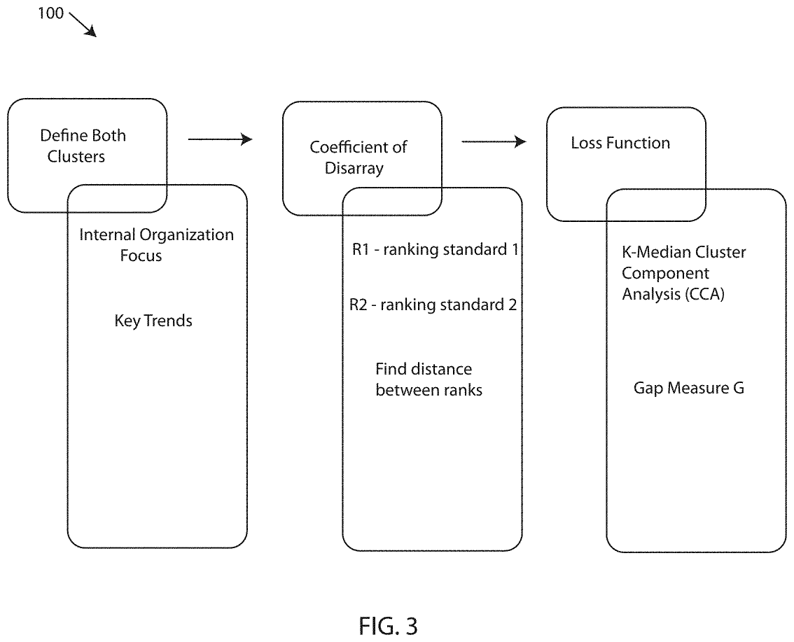

FIG. 3 depicts a block diagram of the overall organization strategy value identification system 100, in accordance with embodiments of the present invention. The overall organization strategy value identification system 100 defines at least two different clusters based on an internal organization focus and key trends in the market/industry. The system 100 finds the distance between a first ranking standard, R1 and a second ranking standard R2. Ranking standard R1 is an internal ranking completed internally by the organization. Ranking standard R2 is a universal ranking standard completed by the system 100 using external data sources focusing on market trends, market data, market and industry-specific analysis, and the like. The system 100 then applies a loss function to extract an actual business impact of a misalignment between the internal rankings of focus areas and universal rankings of focus areas.

Various tasks and specific functions of the modules of the computing system 120 may be performed by additional modules, or may be combined into other module(s) to reduce the number of modules. Further, an embodiment of the computer or computer system 120 comprises specialized, non-generic hardware and circuitry (i.e., specialized discrete non-generic analog, digital, and logic-based circuitry) (independently or in combination) particularized for executing only methods of the present invention. The specialized discrete non-generic analog, digital, and logic-based circuitry includes proprietary specially designed components (e.g., a specialized integrated circuit, such as for example an Application Specific Integrated Circuit (ASIC), designed for only implementing methods of the present invention).

Furthermore, the organization strategy value identification system 100 provides a technical solution to determine: (i) whether an organization has identified all products, services and domains important for the organization's IP filing strategy, (ii) an impact of domains an organization is not currently focusing on as part of a current IP strategy, and (iii) whether there are certain domains of high importance to a given market but are not currently part of the organization's current IP strategy. Failing to include domains of high importance to the market in the patent portfolio building strategy results in an adverse business impact, such as lost opportunities, a devaluing of a patent portfolio, costs incurred for corrective action, etc. Accordingly, the organization strategy value identification system 100 provides a practical application for distinguishing a focus or strategy of an organization from a focus or strategy of an overall market to identify a misalignment between the organization and the market that allows the organization to understand a business impact if the current strategy is not corrected.

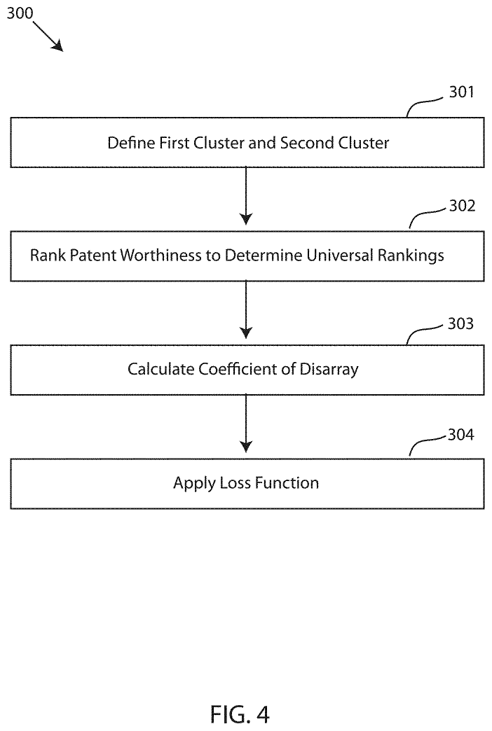

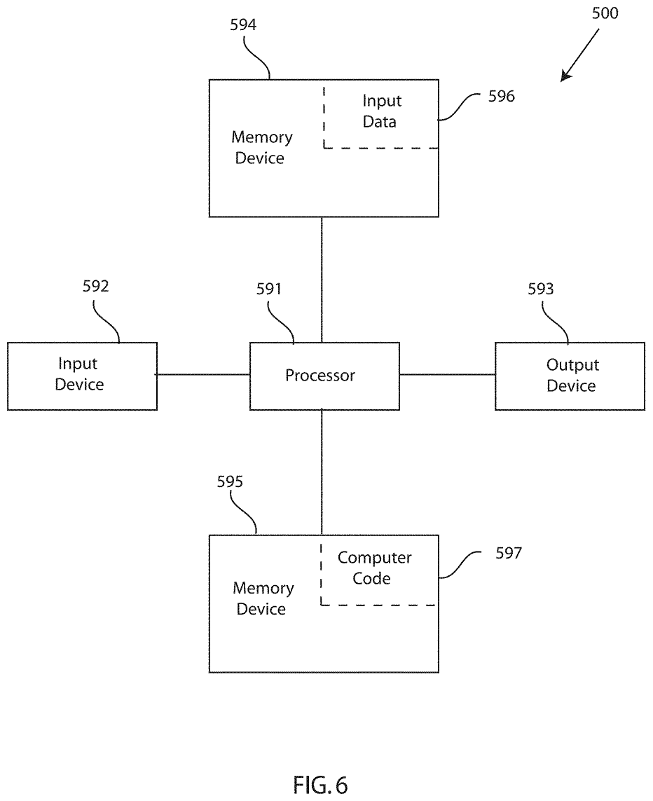

Referring now to FIG. 4, which depicts a flow chart of a method 300 for identifying a value gap in a patent portfolio strategy of an organization, in accordance with embodiments of the present invention. One embodiment of a method 300 or algorithm that may be implemented for identifying a value gap in a patent portfolio building strategy of an organization with the system 100 described in FIGS. 1-3 using one or more computer systems as defined generically in FIG. 6 below, and more specifically by the specific embodiments of FIG. 1.

Embodiments of the method 300 for identifying a value gap in a patent portfolio strategy of an organization, in accordance with embodiments of the present invention, may begin at step 301 wherein step 301 defines the first cluster and the second cluster. Step 302 ranks the patent worthiness of the second cluster (and potentially the first cluster) to determine universal rankings. Step 303 calculates the coefficient of disarray. Step 304 applies a loss function.

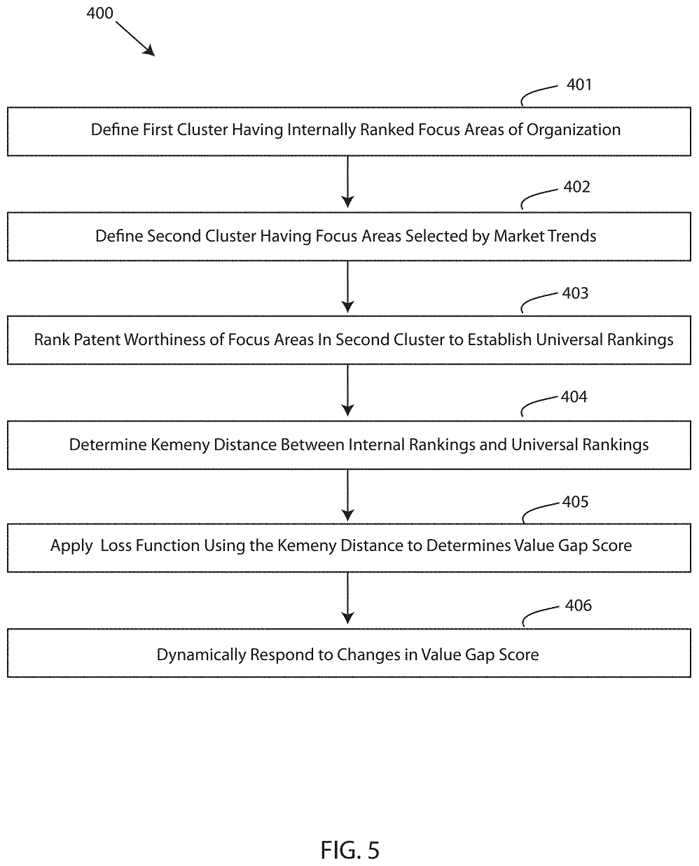

FIG. 5 depicts a more detailed flow chart of a method 400 for identifying a value gap in a patent portfolio strategy of an organization, in accordance with embodiments of the present invention. Step 401 defines a first cluster having internally ranked focus areas of an organization. Step 402 defines a second cluster having focus areas selected based on market trends or a market focus. Step 403 ranks a patent worthiness of focus areas in the second cluster to establish universal rankings. Step 404 determines a Kemeny distance between the internal rankings and the universal rankings, which defines a coefficient of disarray that equates to a misalignment between the organization's patent portfolio building strategy/focus and a market focus. Step 405 applies a loss function using the Kemeny distance to determines a value gap score, defining a business penalty and/or impact that the misalignment causes. Step 406 dynamically responds to changes in the value gap score.

FIG. 6 depicts a block diagram of a computer system for the system 100 of FIGS. 1-3, capable of implementing methods for identifying a value gap in a patent portfolio strategy of an organization of FIGS. 4-5, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer system 500, including executing instructions included in the computer code 597 for the tools and programs capable of implementing a method for identifying a value gap in a patent portfolio strategy of an organization in the manner prescribed by the embodiments of FIGS. 4-5 using the system 100 of FIGS. 1-3, wherein the instructions of the computer code 597 may be executed by processor 591 via memory device 595. The computer code 597 may include software or program instructions that may implement one or more algorithms for implementing the method for identifying a value gap in a patent portfolio strategy of an organization, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a computing device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to identifying a value gap in a patent portfolio strategy of an organization. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer system 500) including one or more processor(s) 591, wherein the processor(s) carry out instructions contained in the computer code 597 causing the computer system to provide assisted-learning with a portable computing device. Another embodiment discloses a process for supporting computer infrastructure, where the process includes integrating computer-readable program code into a computer system 500 including a processor.

The step of integrating includes storing the program code in a computer-readable storage device of the computer system 500 through use of the processor. The program code, upon being executed by the processor, implements a method for identifying a value gap in a patent portfolio strategy of an organization. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for identifying a value gap in a patent portfolio strategy of an organization.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models areas follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

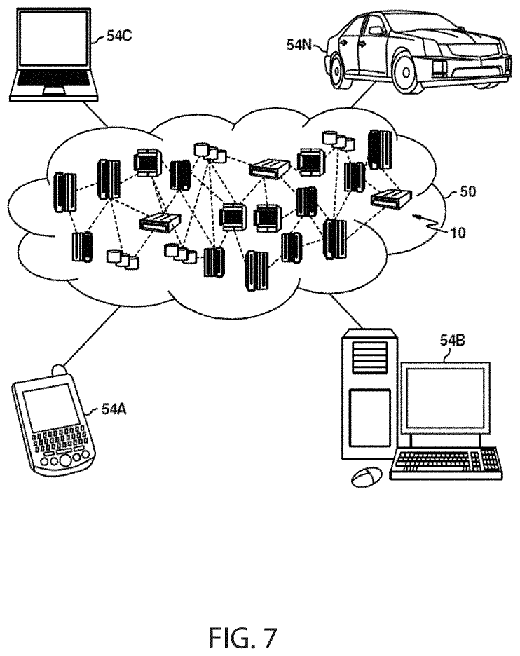

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser).

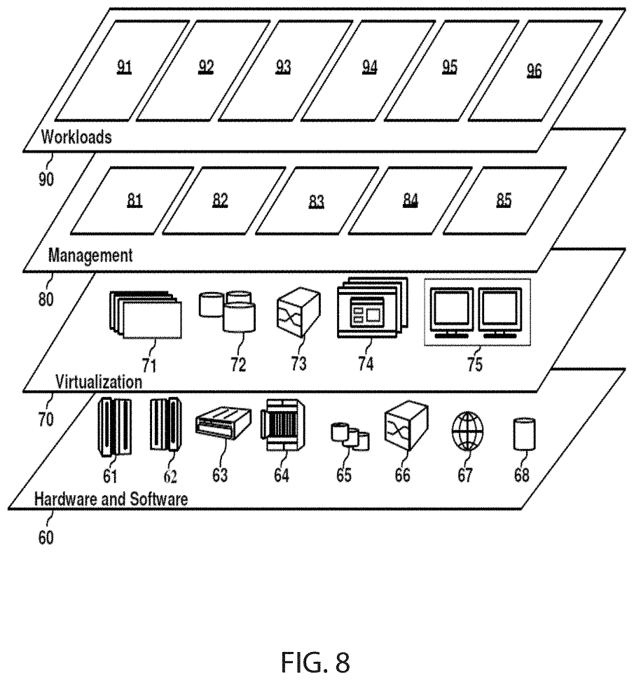

Referring now to FIG. 8, a set of functional abstraction layers provided by cloud computing environment 50 (see FIG. 7) are shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. in some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and GUI and value gap identification 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for identifying a value gap score in a patent portfolio building strategy of an organization, the method comprising:
defining, by a processor of a computing system, a first data cluster that includes a first plurality of focus areas that are ranked according to an internal ranking of the organization, and a second data cluster that includes a second plurality of focus areas having a universal market significance;
ranking, by the processor, a patent worthiness of the second plurality of focus areas using a plurality of factors, so that each focus area of the second plurality of focus areas is ranked according to a universal ranking;
determining, by the processor, a Kemeny distance between the internal ranking and the universal ranking for each focus area of the first plurality of focus areas, wherein the Kemeny distance between the internal ranking and the universal ranking represents a misalignment between the patent portfolio strategy of the organization and a universal market focus; and
applying, by the processor, a loss function using the Kemeny distance to calculate the value gap score which defines a business penalty for the misalignment between the patent portfolio strategy of the organization and a universal market focus.

2. The method of claim 1, wherein the plurality of factors includes a total dollar amount of investments into the focus area, a total number of patent applications filed in the focus area, a number of organizations researching the focus area, and market results linked to the focus area.

3. The method of claim 1, wherein the loss function is a K-Median Cluster Component Analysis as follows:
CCA(P,S₁, . . . ,S_{K})=Σₛ₌₁ⁿΣₖ₌₁^{K}pₖ²(Rₛ)d_{Kem}(Rₛ,Sₖ),
wherein Pₖ(Rₛ) is a probability of allocating ranking s to cluster component k, Sₖ is a center of component k for k=1, . . . , K, and P=P is the n×K matrix of allocation probabilities.

3. The method of claim 1, wherein determining the distance includes calculating, by the processor, a coefficient of disarray to determine a number of switches that transform a ranking of a focus area of the first data cluster into a ranking of the same focus area of the second data cluster.

4. The method of claim 3, wherein the coefficient of disarray is calculated according to the following formula:
$$τ = 1 - \frac{2 s}{\frac{1}{2} n ( n - 1 )} ,$$
wherein τ is the coefficient of disarray, s is a kendal distance, and n is a list size.

6. The method of claim 1, wherein the value gap score is measured according to the formula:
$${G}_{O * U} = \frac{1}{\frac{1}{2} τ ( τ - 1 )} {Σ}_{s ∈ G}^{{n}_{l}} {Σ}_{t ∈ G}^{{n}_{l}} {d}_{Kem} ( {R}_{s} , {S}_{k} ) \vert s > t ,$$
wherein nₗ is a current reference in the internal ranking, and τ is the coefficient of disarray.

7. The method of claim 1, further comprising: recommending, by the processor, one or more modifications to the patent portfolio strategy of the organization to reduce the gap score.

8. A computing system, comprising:
a processor;
a memory device coupled to the processor; and
a computer readable storage device coupled to the processor, wherein the storage device contains program code executable by the processor via the memory device to implement a method for identifying a value gap in a patent portfolio strategy of an organization, the method comprising:
defining, by a processor of a computing system, a first data cluster that includes a first plurality of focus areas that are ranked according to an internal ranking of the organization, and a second data cluster that includes a second plurality of focus areas having a universal market significance;
ranking, by the processor, a patent worthiness of the second plurality of focus areas using a plurality of factors, so that each focus area of the second plurality of focus areas is ranked according to a universal ranking;
determining, by the processor, a Kemeny distance between the internal ranking and the universal ranking for each focus area of the first plurality of focus areas, wherein the Kemeny distance between the internal ranking and the universal ranking represents a misalignment between the patent portfolio strategy of the organization and a universal market focus; and
applying, by the processor, a loss function using the Kemeny distance to calculate the value gap score which defines a business penalty for the misalignment between the patent portfolio strategy of the organization and a universal market focus.

9. The computing system of claim 8, wherein the plurality of factors includes a total dollar amount of investments into the focus area, a total number of patent applications filed in the focus area, a number of organizations researching the focus area, and market results linked to the focus area.

10. The computing system of claim 8, wherein the loss function is a K-Median Cluster Component Analysis as follows:
CCA(P,S₁, . . . ,S_{K})=Σₛ₌₁ⁿΣₖ₌₁^{K}pₖ²(Rₛ)d_{Kem}(Rₛ,Sₖ),
wherein Pₖ(Rₛ) is a probability of allocating ranking s to cluster component k, Sₖ is a center of component k for k=1, . . . , K, and P=P is the n×K matrix of allocation probabilities.

11. The computing system of claim 8, wherein determining the distance includes calculating, by the processor, a coefficient of disarray to determine a number of switches that transform a ranking of a focus area of the first data cluster into a ranking of the same focus area of the second cluster.

12. The computing system of claim 11, wherein the coefficient of disarray is calculated according to the following formula:
$$τ = 1 - \frac{2 s}{\frac{1}{2} n ( n - 1 )} ,$$
wherein τ is the coefficient of disarray, s is a kendal distance, and n is a list size.

13. The computing system of claim 8, wherein the value gap score is measured according to the formula:
$${G}_{O * U} = \frac{1}{\frac{1}{2} τ ( τ - 1 )} {Σ}_{s ∈ G}^{{n}_{l}} {Σ}_{t ∈ G}^{{n}_{l}} {d}_{Kem} ( {R}_{s} , {S}_{k} ) \vert s > t ,$$
wherein nₗ is a current reference in the internal ranking, and τ is the coefficient of disarray.

14. The computing system of claim 8, further comprising: recommending, by the processor, one or more modifications to the patent portfolio strategy of the organization to reduce the gap score.

15. A computer program product, comprising a computer readable hardware storage device storing a computer readable program code, the computer readable program code comprising an algorithm that when executed by a computer processor of a computing system implements a method for identifying a value gap in a patent portfolio strategy of an organization, the method comprising:
defining, by a processor of a computing system, a first data cluster that includes a first plurality of focus areas that are ranked according to an internal ranking of the organization, and a second data cluster that includes a second plurality of focus areas having a universal market significance;
ranking, by the processor, a patent worthiness of the second plurality of focus areas using a plurality of factors, so that each focus area of the second plurality of focus areas is ranked according to a universal ranking;
determining, by the processor, a Kemeny distance between the internal ranking and the universal ranking for each focus area of the first plurality of focus areas, wherein the Kemeny distance between the internal ranking and the universal ranking represents a misalignment between the patent portfolio strategy of the organization and a universal market focus; and
applying, by the processor, a loss function using the Kemeny distance to calculate the value gap score which defines a business penalty for the misalignment between the patent portfolio strategy of the organization and a universal market focus.

16. The computer program product of claim 15, wherein the plurality of factors includes a total dollar amount of investments into the focus area, a total number of patent applications filed in the focus area, a number of organizations researching the focus area, and market results linked to the focus area.

17. The computer program product of claim 15, wherein the loss function is a K-Median Cluster Component Analysis as follows:
CCA(P,S₁, . . . ,S_{K})=Σₛ₌₁ⁿΣₖ₌₁^{K}pₖ²(Rₛ)d_{Kem}(Rₛ,Sₖ),
wherein Pₖ(Rₛ) is a probability of allocating ranking s to cluster component k, Sₖ is a center of component k for k=1, . . . , K, and P=P is the n×K matrix of allocation probabilities.

18. The computer program product of claim 15, wherein determining the distance includes calculating, by the processor, a coefficient of disarray to determine a number of switches that transform a ranking of a focus area of the first data cluster into a ranking of the same focus area of the second cluster.

19. The computer program product of claim 18, wherein the coefficient of disarray is calculated according to the following formula:
$$τ = 1 - \frac{2 s}{\frac{1}{2} n ( n - 1 )} ,$$
wherein τ is the coefficient of disarray, s is a kendal distance, and n is a list size.

20. The computer program product of claim 15, wherein the value gap score is measured according to the formula:
$${G}_{O * U} = \frac{1}{\frac{1}{2} τ ( τ - 1 )} {Σ}_{s ∈ G}^{{n}_{l}} {Σ}_{t ∈ G}^{{n}_{l}} {d}_{Kem} ( {R}_{s} , {S}_{k} ) \vert s > t ,$$
wherein nₗ is a current reference in the internal ranking, and τ is the coefficient of disarray.
